(19) United States
(12) Patent Application Publication
(10) Pub. No.: US 2026/0343240 A1
(43) Pub. Date: Oct. 29, 2026

(54) REMOTE SIM CARD ACCESS DEVICE

(71) Applicant: Oleksii Viktorovych Glib, Chernihiv (UA)

(72) Inventor: Oleksii Viktorovych Glib, Chernihiv (UA)

(21) Appl. No.: 19/646,172

(22) Filed: Apr. 13, 2026

Related U.S. Application Data
(60) Provisional application No. 63/788,663, filed on Apr. 14, 2025.

(51) Int. Cl. H04W 12/50; H04W 4/14; H04W 8/20; H04W 12/033; H04W 12/084

(52) U.S. Cl. CPC H04W 12/50; H04W 4/14; H04W 8/20; H04W 12/033; H04W 12/084

(57) ABSTRACT

Disclosed are example embodiments of a system including a remote SIM hosting device configured to house one or more physical SIM cards. The system also includes a processor within the remote SIM hosting device configured to manage cellular communication using the one or more SIM cards. The system further includes a network interface configured to connect the remote SIM hosting device to the Internet. The system also includes a remote access interface to allow a user device configured to send and receive SMS messages and phone calls using the one or more SIM cards, wherein the user device accesses the remote SIM hosting device over the Internet.

### CROSS-REFERENCE TO RELATED APPLICATION

This application claims priority to U.S. Provisional Patent Application No. 63/788,663, filed on Apr. 14, 2025, the disclosure of which is incorporated herein by reference in its entirety.

### TECHNICAL FIELD

The present disclosure relates generally to telecommunications devices, and more specifically, some embodiments relate to systems and methods for remote management and access using SIM cards via an Internet-connected device.

### BACKGROUND

In modern mobile communications, users often need to maintain multiple phone numbers, especially when they have diversified business or personal activities across multiple countries. Each phone number typically requires a separate SIM card. Most consumer smartphones can only accommodate two SIM cards at a time, which severely limits a user's ability to manage multiple numbers efficiently.

When traveling, users often encounter roaming charges, incompatibility with local networks, or the need to physically swap SIM cards. This creates significant inconvenience, especially for users who want to maintain active numbers in different countries while using only a single mobile device.

Furthermore, the increased reliance on a single phone number for multiple services (e.g., banking, messaging, authentication) introduces security risks. Attackers who gain access to this number can initiate social engineering attacks, SIM swaps, and account takeovers.

Existing solutions for remote SIM management are primarily designed for enterprise call centers, using large and complex GSM gateways that are difficult for individual consumers to deploy and operate. These enterprise systems are also expensive and lack user-friendly interfaces suitable for consumer use.

There remains a need for a compact, personal SIM gateway that allows a user to remotely manage one or more SIM cards through a secure, internet-connected device that can be easily set up and controlled from a smartphone or other personal device.

### SUMMARY

In one example implementation, a system is provided comprising a remote SIM hosting device that houses one or more physical SIM cards and connects to the Internet. The device includes a microcomputer with processing, memory, and communication modules that allow the SIM card to register on a mobile network. At the same time, the user accesses the SIM remotely via a mobile app, web interface, or API.

Disclosed are example embodiments of a system. The system includes a remote SIM hosting device configured to house one or more physical SIM cards. The system also includes a processor within the remote SIM hosting device configured to manage cellular communication using the one or more SIM cards, and a network interface configured to connect the remote SIM hosting device to the Internet. The system further includes a remote access interface configured to allow a user device to send and receive SMS messages and phone calls using the one or more SIM cards over the Internet, wherein the remote SIM hosting device is configured to perform cellular network registration using the one or more SIM cards.

Disclosed are example embodiments of a system. The system includes a remote SIM hosting device configured to house one or more physical SIM cards and a cellular modem configured to register at least one of the one or more physical SIM cards with a cellular network. The system also includes a processor operatively coupled to the cellular modem and configured to receive an incoming communication directed to the at least one SIM card, apply one or more user-defined filtering rules to the incoming communication at the remote SIM hosting device, and selectively block or forward the incoming communication based on the filtering rules. The system further includes a network interface configured to transmit forwarded communications over an Internet connection to a user device, wherein the filtering rules are applied prior to transmission such that blocked communications are prevented from reaching the user device.

Disclosed are example embodiments of a method. The method includes assigning a static identifier to a remote SIM hosting device and generating a temporary pairing token at the remote SIM hosting device. The method also includes broadcasting an advertisement including the static identifier and the temporary pairing token via a wireless interface, detecting the advertisement by a user device, and transmitting a pairing request to a remote service that includes the static identifier and the temporary pairing token. The method further includes validating the pairing request, associating the remote SIM hosting device with a user account in response to successful validation, and transmitting an encryption key to the remote SIM hosting device to enable secure communication between the remote SIM hosting device and the user device.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates an example system architecture of the remote SIM hosting device, including its internal components and communication pathways.

FIG. 2 illustrates an example process flow for remote call and SMS management using the device.

FIG. 3 illustrates a user interface example for configuring call filters, forwarding rules, and security settings via a mobile application.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details to provide a thorough understanding of various concepts. However, it will be apparent to those skilled in the art that these concepts may be practiced without these specific details. In some instances, well-known structures and components are shown in block diagram form in order to avoid obscuring such concepts.

Some embodiments of the systems, methods, and devices described herein may have one or more of the following capabilities. For example, one embodiment of the systems, methods, and devices described herein may generally include telecommunications devices, and, more specifically, systems and methods for remote management and access to SIM cards via an Internet-connected device. Some example embodiments may enable users to make and receive calls and SMS messages from anywhere worldwide without requiring the SIM card to be physically present in the user's phone. This approach may allow users to leave their SIM cards securely at home (or any other location with Internet access) and access their phone numbers from anywhere in the world, even while in flight or countries with different mobile standards, e.g., assuming Internet or other communications access.

In another example implementation, the system may allow the user to make and receive voice calls and SMS messages using the hosted SIM card, with communication relayed over the Internet between the user's phone (or other device) and the SIM card in the remote device. This may eliminate the need to physically swap SIM cards in and out of the user's primary mobile device.

In yet another example implementation, the system may provide additional features such as call and message filtering, time-based call forwarding, and encryption of transmitted data to ensure privacy and security. The system may support any cellular generation (e.g., 2G, 3G, 4G, 5G, and future generations) and may work with standard SIM cards.

The present disclosure relates to a system, method, and device designed to address a widespread yet increasingly complex problem faced by modern mobile phone users, particularly those who manage multiple phone numbers across different countries. Today's global citizens, including professionals, expatriates, frequent travelers, and individuals with diversified personal and business lives, may routinely rely on multiple phone numbers, each of which may be tied to a specific location or purpose. However, modern smartphones are typically limited to supporting only two physical SIM cards, forcing users to either carry multiple phones or constantly swap SIM cards to stay connected. This approach is cumbersome and leads to practical problems such as battery drain from constant network re-registration, accidental loss of SIM cards during swaps, and the risk of exposing sensitive numbers to hostile actors when using public networks.

Some example embodiments may solve this problem by introducing a remote SIM hosting device. This device may be a compact hardware unit that holds one or more SIM cards (or includes one or more virtual SIM cards) and establishes cellular connections on their behalf. The device may remain at a fixed location with reliable internet access. The user may access these SIM cards remotely via an app, web portal, or API from anywhere in the world, allowing them to make and receive calls, send and receive SMS messages, and manage filtering and forwarding rules—all without physically handling the SIM cards or maintaining direct cellular connectivity on their personal device. This architecture may provide a clean separation between the user's actual device and their cellular identities, enhancing both convenience and security.

The problem of multiple phone numbers is particularly pronounced for users managing personal and business identities or those with numbers in different countries to maintain local contactability. When traveling internationally, users often face expensive roaming fees, poor local network compatibility, or the logistical challenge of physically swapping in a new SIM. Moreover, some services—such as WhatsApp—are tied to specific phone numbers at registration, further complicating efforts to maintain seamless global communication. Existing “virtual number” services like Google Voice or Skype provide temporary workarounds. Still, these services mean the user lacks full ownership and control over the number and the services often do not support functions such as receiving SMS verification codes for banking and government services.

The remote SIM hosting device offers a fundamentally different approach by preserving the user's full ownership and control of each, e.g., physical SIM card, while allowing remote, flexible usage. Once a SIM is inserted into the device, communication may be relayed through the Internet to the user's personal device, which no longer needs to manage the SIM directly. This may allow users to retain the benefits of physical SIM ownership—such as reliable receipt of SMS-based two-factor authentication—without suffering the physical constraints of device compatibility or limited SIM slots.

### Comparison to State of the Art

Existing enterprise GSM gateways and call center systems provide remote SIM access, but these systems are cumbersome, expensive, and require significant technical expertise to set up and manage. They are not designed for personal use. Additionally, such systems often introduce latency, noise, and compatibility issues, particularly when calls are converted through complex VoIP backends. These products are inappropriate for individual consumers needing plug-and-play simplicity.

Some example embodiments described herein instead focus on providing a personal and secure remote SIM solution designed to be purchased off-the-shelf, set up in minutes, and controlled through a user-friendly application (“app”) that requires no specialized networking expertise. Some embodiments are intended to offer the simplicity and elegance that drove consumer adoption of the smartphones themselves.

Unlike enterprise GSM gateways that are designed for centralized bulk processing, the present remote SIM hosting device integrates multi-SIM management, remote access, call and message filtering, and device management functionality within a compact, consumer-oriented device. In some embodiments, these functions may be accessible through a unified user interface, which may reduce configuration complexity relative to systems that rely on separate infrastructure components such as dedicated VoIP servers, manual network configuration, or command-line interfaces.

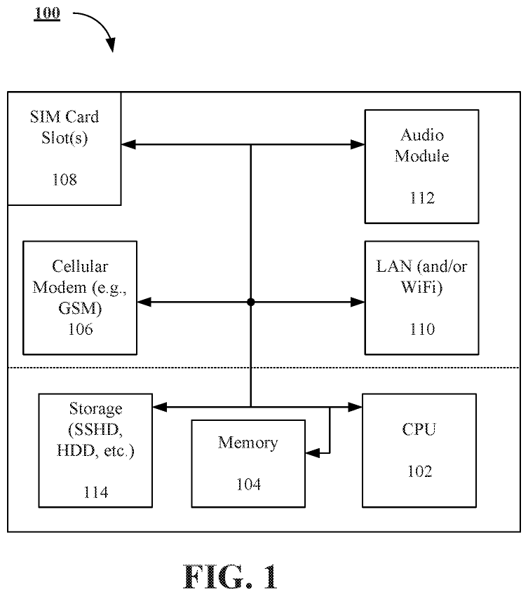

### Technical Implementation (FIG. 1)

Referring to FIG. 1, the remote SIM hosting device 100 comprises a microcomputer with a processor 102 that manages communication, a memory 104 storing configuration data and encryption keys, and a cellular modem 106 capable of registering each installed SIM card to its respective mobile network. The device may include one or more SIM card slots 108, allowing users to manage multiple numbers simultaneously. To reach the Internet, the device supports both wired LAN 110 and WiFi connectivity, ensuring compatibility with typical home and office networks. The device 100 may also include storage 114, which may comprise, for example, one or more solid state drives (SSD), hard disk drives (HDD), NVMe drives, or hybrid drives that combine solid state and spinning disk technologies. In some embodiments, the storage 114 may include removable storage media, such as USB flash drives, SD cards, or external hard drives connected via USB, Thunderbolt, or eSATA interfaces. The storage 114 may include network-attached storage (NAS) devices or access to cloud-based storage platforms, allowing the device to store or retrieve data from distributed storage systems. The storage 114 may also utilize RAID arrays (e.g., RAID 1, RAID 5, RAID 10) for redundancy and performance or encrypted drives to enhance data security.

By co-locating SIM card hosting, cellular network registration, and communication filtering within a single device, some embodiments may provide improved responsiveness and reduced processing overhead compared to systems in which these functions are distributed across multiple components. In particular, filtering logic may access incoming signaling events directly from the cellular modem prior to transmission to the user device, enabling early-stage evaluation and selective blocking of communications. In contrast, systems that rely on indirect forwarding or higher-layer protocol processing may evaluate communications only after additional processing or transmission steps have occurred. This approach reduces signaling overhead and avoids establishing communication sessions for communications that are determined to be blocked. In some embodiments, filtering decisions are made based on signaling information received prior to establishment of a communication session.

In an example embodiment, the remote SIM hosting device may include several interconnected hardware components, including a processor, memory, network interface, and SIM slot(s), each of which may play a role in the overall operation of the system. Proper interconnection between these components may help ensure reliable SIM card management, network registration, and communication handling.

### SIM Slot and Processor Interface

The SIM slot may be directly connected to the processor via a SIM card interface, which may, for example, follow standard ISO 7816 or SIM Card Interface Protocols used in GSM, LTE, and 5G communications. The processor controls SIM authentication, network registration, and command execution, may help ensure that the hosted SIM cards are actively communicating with the mobile network.

### SIM Slot and Cellular Modem

The cellular modem may be responsible for handling network communications and may be connected to the SIM slot through one or more dedicated SIM card signal lines. For example, the connection may include a clock signal (SIM_CLK) that synchronizes communication between the SIM and the modem, a reset signal (SIM_RST) that allows the SIM to be reset when needed, and a data line (SIM_IO) that facilitates bidirectional data communication between the SIM and the modem. The connection may further include a power supply line (SIM_VCC) that provides regulated power to the SIM, which may be, for example, approximately 1.8 volts or 3.0 volts depending on the SIM card type. In some embodiments, additional control or detection lines may be provided to support SIM presence detection or enhanced communication control.

These signal connections may enable the modem to access SIM card data, perform authentication procedures, establish network registration with a cellular network, and transmit or receive communications including voice calls and short message service (SMS) messages.

The processor may be operatively coupled to one or more memory components, including volatile and non-volatile memory. For example, the processor may interface with random access memory (RAM) and flash memory or similar storage technologies.

The RAM may be used for temporary data storage during operation, including storage of active call session data, queued messages, buffering of communication streams, and real-time status information. The flash memory or other non-volatile memory may store firmware, SIM authentication data, call forwarding rules, filtering configurations, encryption parameters, and user preferences. In some embodiments, additional storage media may be used, including removable storage or network-based storage.

This memory architecture may enable rapid access to SIM-related data during active communication while maintaining persistent storage of configuration and operational data across device restarts or power cycles.

The SIM slot and associated modem may interface with a network interface configured to provide connectivity to external networks. The network interface may include, for example, Ethernet, WiFi, or other wired or wireless communication technologies. Through this interface, communication associated with the SIM card may be relayed to a user device over the Internet.

In some embodiments, the modem may generate voice or message signals that are processed by a software layer executing on the processor. The processed signals may then be transmitted to the user device using one or more communication protocols, such as encrypted Web Real-Time Communication (WebRTC) sessions, application programming interfaces (APIs), or other network-based communication mechanisms.

The SIM slot and associated circuitry may be coupled to a power supply subsystem configured to provide appropriate operating voltages. Because different SIM cards may operate at different voltage levels, the system may include a voltage regulator configured to supply a selected voltage level to the SIM card. In some embodiments, power management logic may be provided to maintain stable operation during periods of increased load, such as when multiple SIM cards are active simultaneously, and to prevent unintended power loss or signal disruption.

In some implementations, the system may further support audio handling and signal routing for voice communications. Because the SIM slot interacts with the modem for voice call functionality, analog audio signals may be output from the modem and routed through an audio interface, such as a USB sound card or a digital-to-analog converter (DAC), prior to transmission to the user device.

A software-controlled channel routing mechanism may be employed to manage audio paths associated with one or more SIM cards. For example, the system may map a selected microphone input to a corresponding SIM card, route incoming voice signals from the remote SIM to the appropriate output channel associated with the user device, and apply signal processing techniques such as noise filtering, gain control, or echo cancellation to improve call quality. In some embodiments, alternative audio routing architectures may be used, including fully digital audio processing paths.

By designing these interconnections carefully, the system may achieve seamless remote SIM operation, which may allow users to make and receive calls and messages without physically swapping SIM cards.

### Interconnections between System Blocks and SIM Slot Integration

The remote SIM hosting device may integrate multiple hardware and software components, including the SIM slot, GSM board, processor, memory, network interface, and firmware, to facilitate seamless remote SIM card operation. Understanding the connections between these elements highlights the technical complexity involved in enabling remote SIM access, network registration, and command processing.

The SIM slot and GSM board may communicate through a set of electrical contacts that enable power delivery, data exchange, and control signaling. In some embodiments, the SIM slot may be implemented as a physical holder including a plurality of contact pins, for example between six and eight pins, that interface directly with corresponding contacts on the GSM board. Through these contacts, the GSM board may supply regulated power to the SIM card to activate its internal circuitry, which may operate at a selected voltage level such as approximately 1.8 volts or 3.0 volts depending on the SIM type. The GSM board may further access subscriber authentication data stored on the SIM card during initialization and use this data to perform network registration procedures. In some implementations, the system may support reinitialization of the SIM card, for example by issuing a reset signal or by restarting the GSM module or associated processing components to re-read SIM data.

In one example embodiment, SIM initialization and network registration may be coordinated between the modem and firmware executing on the device. For example, the firmware or application layer may transmit control commands, such as AT commands or similar signaling instructions, to the GSM modem via a communication interface such as a serial port or other interconnect. An operating system, such as a Linux-based system, may facilitate communication between the firmware and the GSM modem by processing and routing the commands. Upon receiving such commands, the GSM modem may utilize previously acquired SIM authentication data to establish a connection with a cellular network. In response to control commands, the GSM modem may generate corresponding network signaling messages and transmit them to the cellular network. The cellular network may return response messages, which are received by the GSM modem and translated into a format suitable for communication with the firmware. The firmware may then process the returned data and perform corresponding actions. This command-response interaction may enable real-time remote SIM operations, including initiating voice calls, sending SMS messages, and managing network connectivity.

In some embodiments, the described command flow may support continuous or near real-time interaction with the cellular network, allowing the system to maintain active communication sessions, queue or process messages, and respond dynamically to network conditions. Variations of this flow may be employed, including alternative command protocols, direct driver-level interactions, or hardware-assisted control mechanisms.

The system may further include a processing and memory architecture configured to support communication operations. A processor, which may include one or more processing units, may execute firmware, operating system processes, and application logic, including handling AT command processing, managing communication sessions, performing data encryption and decryption, and coordinating network interactions. The processor may also handle tasks such as buffering communication streams, scheduling operations, and managing interactions between hardware components.

The processor may be operatively coupled to one or more memory and storage components. For example, volatile memory such as RAM may be used for temporary storage during operation, including storage of active call sessions, temporary message buffers, and real-time system state information. Non-volatile storage, such as flash memory, embedded multimedia card (eMMC), solid-state drives, or other storage media, may store firmware, operating system files, logs, event histories, received messages, and configuration data. In some embodiments, additional storage mechanisms may be used, including removable storage or network-accessible storage.

This combination of processing and memory resources may enable the system to perform SIM-based communication operations, manage persistent and transient data, and support reliable operation under varying load conditions, including scenarios involving multiple simultaneous SIM card operations.

### Network Interface and External Communication

The network interface may facilitate communication with external networks or local devices. In some embodiments, the network interface may include a wired connection, such as a local area network (LAN) or Ethernet interface, which enables reliable connectivity to network infrastructure. In other embodiments, the network interface may include a wireless connection, such as WiFi, allowing the remote SIM hosting device to be positioned flexibly without requiring a physical wired connection. Through the network interface, the device may establish Internet connectivity, which enables remote SIM functionality by allowing users to interact with their SIM cards via mobile applications, web interfaces, application programming interfaces (APIs), or other network-based communication mechanisms.

By structuring these interconnections carefully, the system may help ensure seamless remote SIM access while maintaining network reliability, security, and low-latency communication.

One of the challenges encountered during development was ensuring stable power delivery to the remote SIM hosting device, particularly due to the high energy demands of GSM communication. Some implementations using Power over Ethernet (PoE) boards may be insufficient, as GSM modules exhibited significantly higher power consumption than initially anticipated. To address this, in some embodiments, the design may be revised to incorporate a more robust external power supply, capable of maintaining stable voltage and current delivery even under peak network activity. This adjustment may be used to prevent unexpected device shutdowns, signal drops, and performance degradation, ensuring uninterrupted SIM connectivity.

The microcomputer may run a lightweight operating system, such as Linux or a purpose-built embedded OS, with software capable of monitoring communication events, handling real-time call audio processing via audio module 112, and managing encryption for user-device communication. The device establishes an end-to-end encrypted tunnel between itself and the user's phone, ensuring complete privacy.

A significant challenge arose in handling the audio interface for voice calls. Unlike standard VoIP solutions, which rely on digital audio processing, GSM modules typically provide only analog audio interfaces, and no off-the-shelf hardware currently integrates both GSM and digital audio functionality on a single board. As a result, a custom solution may be used. The current example implementation uses an analog headphone output and microphone input from the GSM board, connected to a USB sound card for processing. A complexity of this approach was ensuring proper channel switching between the microphone and speaker. In a fully digital system, such routing may be managed programmatically in memory, but with the analog interface, physical wiring adjustments were necessary to correctly map microphone inputs to the correct outputs. Overcoming this constraint required meticulous circuit design and signal routing to maintain audio clarity and prevent feedback or signal distortion.

The user may interact with the system through a mobile app or web interface, which may allow complete remote management. The system supports direct peer-to-peer communication when possible, or alternatively routes traffic through a relay server if needed for NAT traversal. In both cases, encryption protects the entire communication path.

Standard GSM modem libraries provide only basic support for sending and receiving AT commands. However, efficient remote SIM management required the development of a custom firmware layer to handle message queuing, error correction, and network resilience. This firmware introduced approximately ten logical commands, some of which were simple AT command wrappers, while others involved sequences of commands to achieve specific outcomes. Additionally, an intelligent connection management system was implemented to detect and recover from internet dropouts, allowing the device to automatically re-establish connections without user intervention. This robust firmware ensured reliable operation in variable network conditions, which is crucial for remote SIM access.

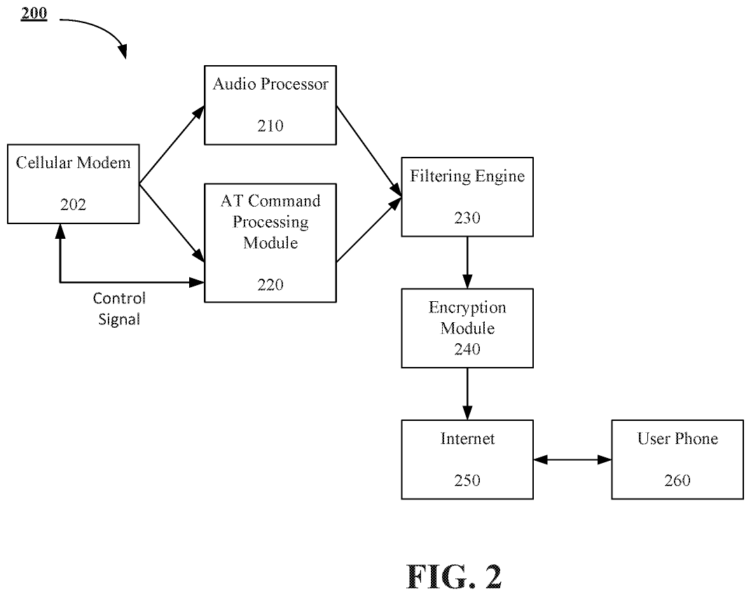

### Process Flow (FIG. 2)

The handling of incoming and outgoing calls and SMS messages is illustrated in FIG. 2. The block diagram 200 illustrates that, when an incoming communication arrives at the device, a cellular modem 202 detects the call or message. The signal may be passed through the audio processor 210 for calls, or an AT Command Processing Module 220 for messages. Communication may flow through a filtering engine 230, where the user's rules—such as blocking spam callers or enabling time-based Do Not Disturb—are applied. The filtered communication is encrypted 240 before being forwarded over the internet 250 to the user's phone. In some embodiments, the filtering engine 230 generates a control signal that is transmitted to the cellular modem 202 to selectively permit, terminate, or prevent establishment of a communication session based on the applied filtering rules.

Another challenge was integrating voice call functionality without relying on heavy and complex VoIP solutions such as Asterisk-based PBX systems, which require significant computing resources and manual configuration. Instead, in one example embodiment, the system was designed to leverage WebRTC, a modern and lightweight protocol widely used in web-based communication platforms. Unlike traditional VoIP implementations, which often require additional servers and intricate configurations, WebRTC allows for seamless peer-to-peer communication with lower latency and built-in encryption. In an example embodiment, the entire VoIP stack was integrated into the firmware, eliminating the need for additional software dependencies while providing a user-friendly and scalable solution.

Outgoing communication follows the reverse path. The user initiates a call or message from their phone, which sends an encrypted instruction to the device. The device decrypts the request, authenticates it, and uses the correct SIM card to place the call or send the message.

Combining communication filtering, remote SIM hosting, and secure remote access into a unified personal device also yields additional benefits in terms of privacy management. For example, by applying filters and redirecting spam calls at the hosting device level, the system ensures that the user's personal device never even rings for unwanted calls. This may provide an improvement over traditional phone-based filtering apps, which must let the call complete before blocking it, a distinction with significant battery life and user-experience implications, especially for travelers reliant on portable devices with limited power.

In some embodiments, the remote SIM hosting device may further include one or more auxiliary hardware interfaces to enhance flexibility across different deployment scenarios. For example, the device may include USB ports, allowing external modems or peripheral sensors to be attached. In certain configurations, a built-in GPS module may be provided to track the device's physical location, which could assist in geofencing applications or regulatory compliance in certain jurisdictions. Additionally, the remote SIM hosting device may incorporate a secure element or hardware security module (HSM) to perform cryptographic operations, such as key generation, storage, and attestation. Such hardware-based security may be beneficial for applications involving highly sensitive communications, such as banking or governmental messaging systems.

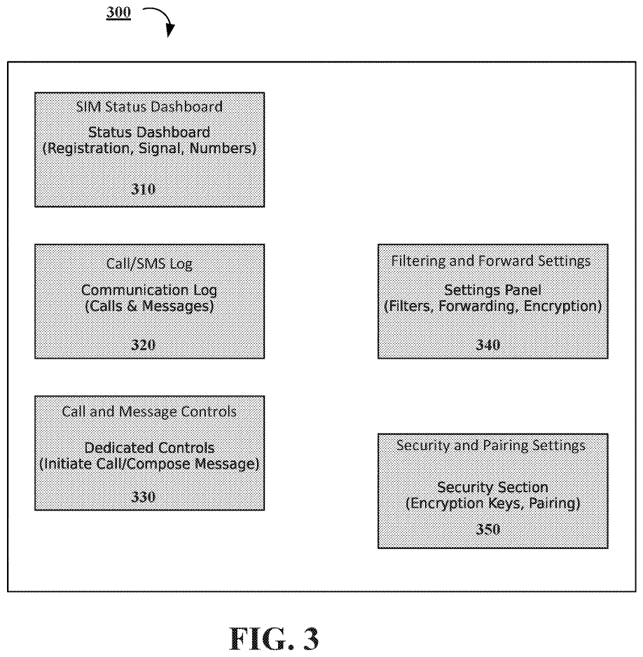

### User Interface (FIG. 3)

FIG. 3 illustrates the companion app interface 300, which provides a consolidated view of active SIMs through a status dashboard 310 showing registration status, network strength, and assigned numbers. A communication log 320 lists calls and messages, while dedicated controls 330 allow the user to initiate calls and compose messages directly within the app.

Furthermore, unlike existing multi-SIM gateways designed for enterprise or industrial use, the present system incorporates consumer-first setup processes, including QR-code pairing, auto-detection of network settings, and interactive setup wizards accessible via mobile app. This combination of advanced cellular management capabilities with consumer-oriented ease of setup addresses an unmet need in the market, bridging a gap between enterprise complexity and consumer usability. This is particularly novel in the context of multi-SIM management across multiple carrier profiles, where current consumer solutions are limited to static dual-SIM phones or cumbersome manual SIM swapping.

The app also includes a settings panel 340 for configuring filters, forwarding, and encryption preferences. A separate security section 350 manages encryption keys and device pairing, ensuring that even if the device is physically compromised, unauthorized access is prevented without the proper keys.

In some embodiments, inputs received via the controls 330 and settings panel 340 generate command messages that are transmitted to the remote SIM hosting device to configure filtering rules, initiate communications, or update security parameters.

### Alternative Configurations

The remote SIM hosting device can be implemented as a single-SIM consumer model or a multi-SIM enterprise version supporting larger deployments. The hardware can be built using off-the-shelf components such as Raspberry Pi boards with USB cellular modems, or as a custom PCB with integrated GSM/LTE/5G modules, reducing size and power consumption. Power can be provided via standard AC adapters or through Power over Ethernet (PoE) for installations where power outlets are unavailable.

### Expanded Use Cases

Various embodiments may serve a range of applications across different user groups and deployment scenarios. For example, in some embodiments, frequent travelers may retain local phone numbers in each country they regularly visit without the need to carry multiple mobile devices. In other embodiments, business users may centrally host employee phone numbers, enabling secure communication and centralized management even for remote or distributed workforces. In some implementations, the system may be used in connection with children's devices, where parents provide data-only SIM cards to the devices while retaining control over voice and SMS functionality through the remote SIM hosting device. In further embodiments, the system may support privacy-focused use cases, allowing users to avoid exposing primary phone numbers when accessing public networks or unfamiliar services, thereby reducing vulnerability to SIM swap attacks or other forms of unauthorized access. In certain scenarios, such as military, journalistic, or other high-risk environments, the system may enable users to maintain communication channels without directly revealing their physical location or primary communication identifiers.

### Operating System-Managed Network Communication

Unlike traditional embedded systems that require firmware-level network management, the present system leverages the operating system (OS) to handle network connectivity, ensuring a streamlined and scalable implementation. The firmware or application does not directly interact with low-level network commands but instead operates at a higher-level protocol layer, relying on the OS to provide the necessary networking environment.

The application communicates with remote servers and other connected devices through standardized network protocols. Secure web-based communication is facilitated through HTTP and HTTPS, ensuring encrypted data transmission. For message queuing and real-time device interactions, the system employs MQTT, which allows lightweight and efficient communication between devices and cloud services. Additionally, the system utilizes TCP-based transmission, prioritizing stable and reliable connections while avoiding User Datagram Protocol (UDP) for the time being due to its inherent lack of reliability and packet ordering guarantees.

By offloading network management to the OS, the system reduces firmware complexity, allowing developers to focus on higher-level features without needing to implement or maintain intricate network stacks. This approach enhances long-term maintainability and provides flexibility for future expansions, such as integrating additional network protocols or security enhancements.

### BLE-Based Single-Step Pairing and Device Initialization

To simplify user onboarding and ensure a seamless setup experience, the system incorporates Bluetooth Low Energy (BLE) for automatic device discovery and pairing. Unlike traditional Bluetooth pairing, which requires manual device selection and connection approval, BLE enables automatic device advertisement and cloud-based authentication, eliminating unnecessary steps in the pairing process.

The pairing mechanism may provide a streamlined setup process by combining local wireless device discovery with remote validation. In some embodiments, the pairing procedure reduces the need for manual configuration steps that are commonly associated with network-based device provisioning. The use of a temporary pairing token and coordinated validation through a remote service may facilitate secure association between the remote SIM hosting device and a user account while limiting exposure to unauthorized pairing attempts.

### Pairing Process Overview

The pairing process is initiated when the device is powered on and connected to a local area network (LAN) with internet access. This internet connection may be established directly or through a gateway providing Dynamic Host Configuration Protocol (DHCP). Once powered, the system executes the following steps to securely associate the device with the user's account:

In one example embodiment, device identification and advertisement may be performed as follows. Each device may be assigned a static identifier, such as a serial code (SC), that uniquely identifies the device within the system. Upon initialization, the device or an associated application may generate a temporary pairing token, such as a randomly generated string (e.g., a 16-character string (RS)), which may be regenerated upon each reboot or at defined intervals until pairing is completed. A mobile application may transmit the SC, the temporary pairing token, and a device identifier associated with the mobile application to a cloud-based pairing service. Substantially concurrently, the device may advertise itself via a wireless interface, such as a Bluetooth Low Energy (BLE) interface, by broadcasting an identifier that includes the SC and the temporary pairing token, for example in the format sq_{SC}_{RS}. In some embodiments, the advertised identifier may include additional information or may use alternative formats, provided that the identifier enables correlation between the device and the temporary pairing token. The advertisement may render the device discoverable to nearby mobile devices attempting to initiate pairing.

In one example embodiment, device discovery and cloud-based authentication may proceed as follows. The mobile application may enter a pairing mode and scan for nearby devices advertising identifiers that satisfy one or more matching criteria, such as a predefined prefix or format. Upon detecting a candidate device, the mobile application may transmit a pairing request to the cloud-based pairing service. The pairing request may include a user account identifier, the discovered device identifier, and a generated encryption key (encKey) or similar cryptographic material for subsequent secure communication. In some embodiments, the pairing request may further include a device identifier of the mobile application or additional authentication data. The pairing service may validate the request by extracting the static identifier and the temporary pairing token from the advertised identifier and determining whether the extracted values correspond to a device that is designated as available for pairing within a maintained dataset. Validation may include comparing the temporary pairing token against a stored or expected value, verifying freshness of the token, or confirming that the device is in a pairing-enabled state. Upon successful validation, the pairing service may associate the device with the user account and may store or update corresponding account-device mappings.

In one example embodiment, finalizing the pairing may include transmitting, by the cloud-based pairing service, a user identifier and the encryption key (or data derived therefrom) to the device. The device may store the user identifier in non-volatile or persistent storage and may remove or avoid persisting the encryption key in long-term memory after initial configuration, thereby reducing exposure to unauthorized access. In some embodiments, the encryption key may be used to derive one or more session keys for subsequent communication. The cloud-based pairing service may further transmit a confirmation message to the mobile application, the confirmation message including a device identifier or other indication that pairing has been successfully completed. In some implementations, the system may perform additional verification steps, retry procedures, or state transitions prior to confirming pairing, and may support re-initiation of the pairing process if validation fails.

This BLE-based pairing approach eliminates the need for manual network configuration, providing a frictionless onboarding process for users. Unlike traditional Bluetooth pairing methods that require step-by-step manual intervention, this method leverages automatic device advertisement and cloud verification, significantly reducing setup time and complexity. The process also ensures a high level of security by employing a randomized pairing token (RS) and an encryption key that is never stored long-term, reducing the risk of unauthorized device access.

By integrating BLE with cloud-based authentication, the system may provide a pairing process that is faster and more reliable while maintaining strong security measures. The combination of LAN connectivity, BLE-based device advertisement, and cloud-based validation may differ from conventional SIM management approaches and may facilitate streamlined deployment in consumer-oriented remote SIM hosting applications.

### Example Scenario

A user working in Europe, with family in the U.S. and business clients in Asia, can place their SIM cards into the device, leave it running at home, and use a single phone to manage calls and messages from anywhere in the world. Calls and texts flow securely through the device over the Internet to the user's app. When traveling, the user buys a local data SIM, using it only for internet access—never exposing any sensitive phone numbers to the local network.

Some example systems combining hardware, software, encryption, filtering, and app-based management, creates a seamless bridge between physical SIM ownership and modern remote communication needs, solving the long-standing challenge of multi-number management for globally active users.

The system includes a remote SIM hosting device, which is a physical apparatus designed to house one or more physical SIM cards. This remote SIM hosting device can take many forms depending on its intended environment and use case. For example, it may be a compact desktop enclosure intended for home use, a rack-mounted unit suitable for data center deployment, or even a ruggedized outdoor unit designed for remote or industrial locations. The device may feature standard slots or trays capable of accommodating various SIM form factors, including Mini-SIM, Micro-SIM, and Nano-SIM. In addition to physical SIM cards, the device may also support embedded SIMs (eSIM), where the SIM functionality is provided through a permanently soldered chip that can be remotely provisioned with carrier profiles. The mechanical design of the housing may include features such as spring-loaded trays, locking covers, or tamper-evident seals to protect the integrity and security of the housed SIMs. Furthermore, the housing may incorporate environmental protection features such as dust resistance, temperature management, or electromagnetic shielding to ensure reliable operation even in challenging deployment conditions.

Within the remote SIM hosting device, a processor is provided to manage cellular communications using the one or more SIM cards. The term “processor” should be understood in its broadest sense to encompass virtually any form of computing or logic circuitry capable of performing various functions. This includes general-purpose microprocessors, microcontrollers, digital signal processors (DSPs), application-specific integrated circuits (ASICs), and field-programmable gate arrays (FPGAs). In some embodiments, the processor may comprise a combination of multiple processing elements, such as a primary microprocessor responsible for higher-level application logic, paired with a dedicated hardware module or real-time processor responsible for low-level signaling and SIM communication tasks. In some example embodiments, the processor may manage the functions for cellular communication, including authenticating the SIM card to the carrier network, performing network registration, handling encryption and decryption of signaling and user data, and ensuring that the remote SIM can send and receive SMS messages, initiate and receive voice calls, and access mobile data networks. In cases where multiple SIM cards are present, the processor may also handle selection and switching between SIMs, potentially allowing different SIMs to be assigned to different users or applications.

In one example embodiment, a system is provided for managing communication using one or more remote subscriber identity module (SIM) cards, wherein the system includes a remote SIM hosting device configured to house one or more physical SIM cards and to enable remote access to communication services associated with the one or more SIM cards.

The remote SIM hosting device may include one or more processors, a memory, a cellular modem, one or more SIM card interfaces, and a network interface. The cellular modem may be configured to register at least one SIM card with a cellular network using standard cellular communication protocols, thereby enabling the remote SIM hosting device to send and receive communications, including voice calls and short message service (SMS) messages, using the SIM card.

In this example embodiment, the processor may be configured to receive incoming communications directed to the SIM card via the cellular modem. The incoming communications may include signaling events corresponding to voice calls, SMS messages, or other SIM-based communication services.

The processor may apply one or more user-defined filtering rules to the incoming communications at the remote SIM hosting device prior to forwarding the communications to a user device. The filtering rules may be stored in memory and may be dynamically configurable via a user interface associated with the user device.

The filtering rules may include, for example, caller identification filtering, time-based rules, contact list matching, spam detection criteria, or combinations thereof. In some embodiments, the filtering rules may include pattern matching, heuristic analysis, or machine-learning-based classification of incoming communications.

In some implementations, the processor may evaluate multiple filtering rules in a prioritized sequence. Each rule may be assigned a priority level, and the processor may apply higher-priority rules before lower-priority rules. The processor may terminate rule evaluation upon determining that a communication satisfies a blocking condition.

In certain embodiments, different filtering rule sets may be associated with different SIM cards, enabling SIM-specific communication handling. For example, a first SIM card associated with business use may apply stricter filtering rules than a second SIM card associated with personal use.

In some embodiments, the processor may obtain signaling information directly from the cellular modem, including caller identification, timestamp data, and network signaling parameters. The processor may apply filtering rules using the signaling information prior to establishing a communication session, thereby preventing unnecessary session establishment for communications that are ultimately blocked.

Based on the filtering rules, the processor may selectively block or forward incoming communications. In cases where a communication is blocked, the communication may be prevented from being transmitted to the user device, such that the user device does not receive a notification, alert, or indication of the blocked communication.

In some implementations, blocked communications may be logged in a communication history stored in memory. The communication history may be accessible to the user via a user interface and may include metadata such as caller identification, timestamp, and blocking reason.

In cases where a communication is forwarded, the processor may prepare the communication for transmission to the user device. The communication may include, for example, audio data corresponding to a voice call or message data corresponding to an SMS message.

In some embodiments, the processor may encrypt forwarded communications prior to transmission over an Internet connection to the user device. The encryption may be performed using one or more encryption keys associated with the user device or a user account.

The remote SIM hosting device may establish a secure communication channel with the user device. In some implementations, the secure communication channel may include a Web Real-Time Communication (WebRTC) peer-to-peer connection. In other implementations, the system may route communication through one or more relay servers when direct peer-to-peer connectivity is unavailable.

The secure communication channel may support bidirectional communication. Incoming communications received from the cellular modem may be encrypted and transmitted to the user device, while outgoing communication instructions received from the user device may be encrypted prior to transmission to the remote SIM hosting device.

The processor may decrypt outgoing communication instructions and translate the instructions into commands executable by the cellular modem. For example, the processor may generate AT commands or equivalent control signals to initiate a voice call or send an SMS message using the SIM card.

In some embodiments, the processor may manage real-time audio streams associated with voice calls. Analog audio signals received from the cellular modem may be converted into digital audio streams and transmitted over the secure communication channel. Conversely, digital audio data received from the user device may be converted into signals suitable for transmission via the cellular modem.

The processor may monitor the status of the secure communication channel and may automatically attempt reconnection upon detecting a network interruption. In some implementations, the system may queue communication data during temporary disconnections and transmit the queued data upon re-establishment of connectivity.

In some embodiments, the encryption process may include generation of session-specific keys derived from a base encryption key. The system may support key rotation or re-keying to enhance long-term communication security.

In some embodiments, the system may include a pairing process for associating the remote SIM hosting device with a user account. The remote SIM hosting device may be assigned a static identifier that uniquely identifies the device.

The remote SIM hosting device may generate a temporary pairing token, which may be a randomly generated string. The temporary pairing token may be regenerated upon each reboot of the device or at periodic intervals until pairing is successfully completed.

The remote SIM hosting device may broadcast an advertisement via a wireless interface, such as a Bluetooth Low Energy (BLE) interface. The advertisement may include the static identifier and the temporary pairing token. In some embodiments, the advertisement may include a device name formatted to incorporate both the static identifier and the temporary pairing token.

A user device may detect the advertisement and initiate a pairing process. The user device may transmit a pairing request to a remote service, wherein the pairing request includes the static identifier, the temporary pairing token, and optionally a device identifier associated with the user device.

The remote service may validate the pairing request by comparing the received static identifier and temporary pairing token with a dataset of devices that are designated as available for pairing. If the validation is unsuccessful, the pairing request may be rejected and the user device may be prompted to retry the pairing process.

Upon successful validation, the remote service may associate the remote SIM hosting device with a user account. The remote service may then transmit an encryption key to the remote SIM hosting device to enable secure communication.

In some embodiments, the remote SIM hosting device may store a user identifier associated with the user account and may delete the encryption key from volatile memory after initial configuration, thereby reducing the risk of unauthorized access.

In some implementations, the pairing process may be performed automatically without requiring manual entry of credentials at the remote SIM hosting device. The remote SIM hosting device may remain in a pairing-enabled state until successful association occurs.

In some embodiments, the remote SIM hosting device may be connected to a local area network prior to broadcasting the advertisement, enabling communication with the remote service during the pairing process.

In some implementations, the system may maintain a pairing state machine, wherein the remote SIM hosting device transitions between states including unpaired, advertising, awaiting validation, paired, and authenticated states.

In this example embodiment, the remote SIM hosting device may integrate device-level communication filtering, secure encrypted communication, and automated pairing to provide remote access to SIM-based communication services.

The combination of applying filtering rules at the remote SIM hosting device prior to forwarding communications, establishing a secure communication channel for bidirectional data exchange, and utilizing a BLE-based pairing mechanism with cloud validation may enable improved security, reduced unwanted communication exposure at the user device, and simplified device onboarding.

While the foregoing describes specific example implementations, it should be understood that the described functionality may be implemented using various combinations of hardware, firmware, and software components, and that alternative implementations may be employed without departing from the scope of the present disclosure.

In embodiments supporting multiple SIM cards, the remote SIM hosting device may include logic to dynamically select an appropriate SIM card for outgoing communications. The selection criteria may be based on factors such as current signal strength, network type (e.g., 4G vs. 5G), current roaming status, cost of service for a given destination, or user preferences defined via the management interface. For example, the user may configure the device to prefer a SIM card from a local carrier when making calls to local numbers, while automatically selecting an international SIM for cross-border calls. This intelligent routing capability may reduce costs and enhance performance without requiring constant manual intervention by the user.

Additionally, some embodiments implement context-aware dynamic SIM selection logic not found in conventional GSM gateways or consumer devices. This logic considers real-time factors such as signal quality across SIMs, network registration success rates, and historical carrier reliability to automatically select the optimal SIM for each outgoing communication event. Unlike manual SIM selection processes common in dual-SIM phones, which require user intervention, this system performs continuous background monitoring and applies configurable user preferences to proactively select the most appropriate SIM based on evolving network conditions and user-defined cost or quality priorities. This intelligent switching system, applied to remote SIM hosting, addresses an unsolved pain point for frequent travelers who juggle multiple SIMs across changing jurisdictions.

The remote SIM hosting device is further equipped with a network interface that connects the device to the Internet. This network interface may be implemented as a wired Ethernet port, a wireless WiFi transceiver, or a combination of both, providing flexible connectivity options to suit a variety of environments. The wired interface may support standard Ethernet speeds, such as 100 Mbps, 1 Gbps, or even 10 Gbps in high-performance variants. In some embodiments, the wired connection may also support Power over Ethernet (PoE), allowing the remote SIM hosting device to receive both power and data over a single Ethernet cable. The wireless interface may support WiFi standards ranging from legacy 802.11b/g to modern WiFi 6 (802.11ax), providing compatibility with a broad range of network infrastructure. In some cases, the device may also include a cellular uplink of its own, allowing it to maintain its internet connection via a separate mobile network when no local wired or wireless network is available. The network interface may also incorporate advanced features such as dynamic DNS support, firewall capabilities, and the ability to maintain a persistent VPN connection for secure remote access. In certain configurations, the remote SIM hosting device may itself be equipped with a dedicated cellular uplink interface, independent of the SIM cards being hosted for user access. This uplink allows the device to maintain its own primary or backup internet connection, ensuring that it remains reachable even if local wired or WiFi infrastructure fails. The uplink may support low-bandwidth protocols optimized for reliability, such as LTE Cat M1 or NB-IoT, reducing operational cost in backup scenarios. This capability may be particularly useful for remote deployments, where wired Internet is unavailable or unreliable.

A remote access interface is provided to allow a user device to send and receive SMS messages and phone calls using the SIM cards housed within the remote SIM hosting device. This remote access interface is designed to operate over the Internet, enabling the user device to interact with the remote SIM as if the SIM were physically present within the user device itself. The remote access interface can take multiple forms, including a dedicated mobile application installed on the user device, a web-based portal accessible through a browser, or an API that allows third-party applications to integrate remote SIM functionality directly. Through this interface, the user device can compose and send SMS messages, read incoming messages, initiate voice calls, and receive incoming calls. The remote access interface may support advanced capabilities such as real-time audio streaming for voice calls, contact management, call history retrieval, and the ability to manage SIM-specific settings remotely. For enhanced security, the remote access interface may also implement end-to-end encryption, ensuring that messages and voice data exchanged between the user device and the remote SIM hosting device remain private and tamper-resistant.

Traditional remote SIM gateways typically rely on network-layer security (e.g., VPN tunnels or TLS connections), but embodiments of the present system add application-layer end-to-end encryption directly between the user device and the hosted SIM process, ensuring that even a compromise of the hosting device's operating system does not expose communication content. This design—separating device management traffic from user communication traffic, with independent encryption keys for each—creates a multi-layer security envelope that is particularly well-suited to consumer deployments where users have limited trust in network operators, home routers, or even their own ISP.

In some implementations, the system may further include a filtering module that applies user-defined rules to incoming communications. This filtering module can be configured to block or forward messages and calls based on criteria specified by the user. For example, rules could be based on the phone number of the sender or caller, the time of day, or even the content of the message itself. Content-based filtering could involve keyword detection, regular expression matching, or even more advanced techniques such as machine learning-based content classification. The filtering module allows users to block spam, enforce do-not-disturb hours, or automatically forward specific types of messages to another number or email address.

The remote access interface may also provide a dedicated encrypted communication channel between the remote SIM hosting device and the user device. This encryption ensures that data passing over the public Internet remains secure from interception or tampering. The encryption mechanism could be based on TLS (Transport Layer Security) for transport encryption, or it could implement additional application-layer encryption using symmetric or asymmetric key pairs. In some embodiments, the system may implement a double-encryption scheme where the transport layer is encrypted using TLS, and the payload itself is encrypted using end-to-end encryption techniques.

The network interface itself may support various configurations, including both wired and wireless connections. A wired LAN connection can provide a stable, high-bandwidth link in fixed installations, while a wireless WiFi connection allows flexible placement without requiring proximity to a network drop. In systems designed for maximum flexibility, both wired and wireless interfaces may be present, with the device automatically selecting the preferred interface based on availability and signal quality.

The remote SIM hosting device is designed to support multiple generations of cellular networks, ensuring compatibility with both legacy systems and future technologies. Supported networks may include 2G systems such as GSM and GPRS, 3G systems such as UMTS and HSPA, 4G LTE networks, and emerging 5G networks. This forward compatibility ensures that the device remains useful as mobile networks evolve, and in some cases, software-defined radio techniques may be used to add support for new frequency bands and protocols through firmware updates.

To simplify user management and configuration, the system may include a web-based management interface accessible via the network. This management interface allows users to configure SIM card settings, define communication filters and forwarding rules, adjust encryption settings, and monitor communication logs. The management interface may also provide diagnostic tools, such as signal strength monitoring and SIM health checks, and may offer firmware update capabilities to ensure that the remote SIM hosting device stays up-to-date with the latest software and security features.

To further enhance reliability and long-term usability, the remote SIM hosting device may incorporate continuous self-monitoring and reporting capabilities. In some embodiments, the device periodically runs hardware health diagnostics, including SIM slot connectivity checks, signal strength monitoring, and internal temperature readings. This health data may be relayed to the user's mobile app or web portal, allowing proactive identification of issues such as degraded cellular reception or a failing SIM card. In some cases, the system may recommend corrective actions, such as reorienting the antenna, upgrading firmware, or replacing a failing hardware component. Remote firmware updates may be applied securely via an encrypted channel, ensuring the device remains compliant with evolving carrier requirements and security standards.

In embodiments where the device is intended for low-power deployment, the remote SIM hosting device may be designed to operate solely using power supplied via Power over Ethernet (PoE). This eliminates the need for a separate power supply, simplifying installation and ensuring reliable operation in locations where AC power may not be readily available.

To enhance security, the system may further include a pairing mechanism that requires an initial authentication handshake between the user device and the remote SIM hosting device before any communication is permitted. This pairing process could involve scanning a QR code displayed on the remote SIM hosting device, exchanging public keys, or completing an out-of-band verification step such as entering a one-time password sent via SMS.

In certain configurations, the remote SIM hosting device may support multiple levels of authentication and user management. For example, in addition to the initial pairing mechanism, the system may implement multi-factor authentication (MFA) each time a new device attempts to connect to the remote SIM hosting device. This could involve both a device-specific certificate and a one-time password sent to a predefined trusted contact method. In some implementations, role-based access control (RBAC) may be applied, allowing different users to access only specific SIM slots or manage only certain communication functions. For example, a parent may grant a child read-only access to message history, while reserving administrative controls for themselves. These flexible user management capabilities enhance the device's suitability for shared family use or small-business environments.

Finally, the remote SIM hosting device may be designed to manage multiple SIM cards simultaneously, each associated with a different phone number. This multi-SIM capability allows the system to serve multiple users concurrently, with each user device assigned to a specific SIM slot or profile. The processor within the device can dynamically switch between SIM cards, either in response to user requests or according to predefined policies, such as load balancing or geographic optimization. This multi-SIM capability makes the system particularly suitable for business environments, where a single device can provide remote access to a pool of corporate phone numbers, or for international travelers, who may wish to maintain simultaneous access to SIMs from multiple countries.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the method steps. The structure for a variety of these example systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system comprising:
a remote SIM hosting device configured to house one or more physical SIM cards;
a processor within the remote SIM hosting device configured to manage cellular communication using the one or more SIM cards;
a network interface configured to connect the remote SIM hosting device to the Internet; and
a remote access interface configured to allow a user device to send and receive SMS messages and phone calls using the one or more SIM cards, wherein the user device accesses the remote SIM hosting device over the Internet,
wherein the remote SIM hosting device is configured to perform cellular network registration using the one or more SIM cards.

2. The system of claim 1, further comprising a filtering module configured to apply user-defined rules to block or forward incoming communications prior to transmission to the user device.

3. The system of claim 1, wherein the remote access interface provides an encrypted communication channel between the remote SIM hosting device and the user device.

4. The system of claim 1, wherein the remote SIM hosting device is configured to manage multiple SIM cards simultaneously, each associated with a different phone number.

5. A system for managing communication using one or more remote SIM cards, the system comprising:
a remote SIM hosting device configured to house one or more physical SIM cards;
a cellular modem configured to register at least one of the one or more physical SIM cards with a cellular network;
a processor operatively coupled to the cellular modem and configured to:
receive an incoming communication directed to the at least one SIM card;
apply one or more user-defined filtering rules to the incoming communication at the remote SIM hosting device; and
selectively block or forward the incoming communication based on the filtering rules; and
a network interface configured to transmit forwarded communications over an Internet connection to a user device,
wherein the filtering rules are applied prior to transmission of the incoming communication to the user device such that blocked communications are prevented from reaching the user device.

6. The system of claim 5, wherein the filtering rules include at least one of: caller identification filtering, time-based rules, contact list matching, or spam detection criteria.

7. The system of claim 5, wherein blocked communications are prevented from generating a notification or alert at the user device.

8. The system of claim 5, wherein the processor is further configured to log blocked communications in a communication history accessible via a user interface.

9. The system of claim 5, wherein forwarded communications are encrypted prior to transmission to the user device.

10. The system of claim 5, wherein the incoming communication includes at least one of a voice call or a short message service (SMS) message.

11. The system of claim 5, wherein the processor applies the filtering rules using signaling information obtained directly from the cellular modem prior to protocol conversion or forwarding.

12. The system of claim 5, wherein the filtering rules include a do-not-disturb schedule that prevents forwarding of communications during defined time intervals.

13. A method for securely pairing a remote SIM hosting device with a user account, the method comprising:
assigning a static identifier to the remote SIM hosting device;
generating a temporary pairing token at the remote SIM hosting device;
broadcasting, via a wireless interface, an advertisement including the static identifier and the temporary pairing token;
detecting, by a user device, the advertisement;
transmitting, by the user device, a pairing request to a remote service, the pairing request including the static identifier and the temporary pairing token;
validating, by the remote service, the pairing request based on the static identifier and the temporary pairing token;
associating the remote SIM hosting device with a user account in response to successful validation; and
transmitting an encryption key to the remote SIM hosting device to enable secure communication between the remote SIM hosting device and the user device.

14. The method of claim 13, wherein the temporary pairing token is regenerated upon each device reboot until pairing is completed.

15. The method of claim 13, wherein the wireless interface comprises a Bluetooth Low Energy (BLE) interface.

16. The method of claim 15, wherein the advertisement includes a device name formatted to include the static identifier and the temporary pairing token.

17. The method of claim 13, wherein the encryption key is deleted from volatile memory of the remote SIM hosting device after initial storage of an associated user identifier.

18. The method of claim 13, wherein validating the pairing request comprises determining that the static identifier and temporary pairing token match a list of devices available for pairing.

19. The method of claim 13, wherein the pairing request further includes a device identifier of the user device.

20. The method of claim 13, further comprising automatically initiating pairing without requiring manual entry of credentials at the remote SIM hosting device.
